(19) United States
(12) Patent Application Publication
(10) Pub. No.: US 2014/0202497 A1
(43) Pub. Date: Jul. 24, 2014

(54) METHODS AND APPARATUS TO MONITOR AND CONTROL CLEANING SYSTEMS

(71) Applicant: Durr Ecoclean GmbH, Filderstadt (DE)

(72) Inventors: Thomas Kreis, Drolshagen/Schlade (DE); Hermann-Josef David, Monschau (DE); Egon Käske, Aachen (DE)

(73) Assignee: Durr Ecoclean GmbH, Filderstadt (DE)

(21) Appl. No.: 14/219,779

(22) Filed: Mar. 19, 2014

Related U.S. Application Data
(63) Continuation-in-part of application No. PCT/EP2012/068510, filed on Sep. 20, 2012.

(30) Foreign Application Priority Data
Sep. 20, 2011 (DE) 10 2011 083 081.2
Jan. 17, 2012 (DE) 10 2012 200 612.5
Jan. 17, 2014 (DE) 10 2012 200 614.1

(51) Int. Cl. B08B 3/04; G01M 99/00

(52) U.S. Cl. CPC B08B 3/04; G01M 99/00
USPC 134/18; 134/113; 134/56 R; 73/865.9

(57) ABSTRACT

Methods and apparatus to monitor and control cleaning systems are disclosed. One disclosed example method includes detecting initial contamination of workpieces before cleaning and detecting residual contamination of workpieces after cleaning. The example method also includes determining, via a processor, a system malfunction from a comparison of the initial contamination with a first threshold value and from a comparison of the final contamination with a second threshold value. The system malfunction is determined from one or more of the determined initial contamination undershoots the first threshold value and the determined final contamination exceeds the second threshold value, the determined initial contamination exceeds the first threshold value and the determined final contamination exceeds the second threshold value, or the determined final contamination remains substantially constant for successive workpieces and exceeds the second threshold value with an absolute value that remains substantially constant.

### RELATED APPLICATIONS

This patent arises from a continuation-in-part of International Patent Application No. PCT/EP2012/068510, which was filed on Sep. 20, 2012, which claims priority to German Patent Application No. 10 2011 083 081, which was filed on September 20, 2011, German Patent Application No. 10 2012 200 612, which was filed on Jan. 17, 2012, and German Patent Application 10 2012 200 614, which was filed on Jan. 17, 2012. The foregoing International Patent Application and German Patent Applications are hereby incorporated herein by reference in their entireties.

### FIELD OF THE DISCLOSURE

This disclosure relates generally to cleaning systems, and, more particularly, to methods and apparatus to monitor and control cleaning systems.

### BACKGROUND

Dirt particles (e.g., swarf, dust, casting sand, liquid droplets, etc.) may impair the function of industrially produced products, such as, for example, injection nozzles of internal combustion engines. Therefore, the cleanliness of workpieces in certain industrial production processes is highly significant.

Consequently, systems to clean workpieces are used in industrial fabrication, in which the workpieces are cleaned with fluid (e.g., liquid, water that may preferably have cleaning additives, or liquids containing hydrocarbons, etc.). Gaseous fluids, for example, compressed air, may be used to clean workpieces. Typically, cleaning fluid used in cleaning systems is generally circulated and used in industrial systems over time periods which commonly last several months. The cleaning effect of circulated cleaning fluid is, thus, generally not constant. It may vary, for example, on impurities (e.g., particles and films that are placed into the cleaning fluid during the cleaning of workpieces). The impurities present within cleaning fluid may reduce the cleaning effect of the cleaning fluid. Because impurities cannot be completely removed even with complex processing systems, conventional cleaning systems typically actuate the pumps circulating cleaning fluid for a high throughput of fluid to ensure that a predefined cleaning effect level is maintained even in examples where cleaning fluid is contaminated. Typically, high energy consumption is necessary during the operation of such systems to maintain a desired cleaning effect.

Incorrect operation of cleaning systems may result in insufficiently cleaned, contaminated workpieces processed and mounted to form complex assemblies. Ensuring the cleanliness of such workpieces is, therefore, important, for example, before intermediate assembly and final assembly steps. To monitor the functioning of cleaning systems (e.g., cleaning system effectiveness), generally individual workpieces are taken off of a production line as part of a sampling and examined (e.g., inspected) for contamination (e.g., contamination) in a testing station separate from the production line.

### BRIEF DESCRIPTION OF THE DRAWINGS

FIG. 1 shows an example cleaning system having a closed-loop control device for a process parameter of a cleaning process in accordance with the teachings of this disclosure.

FIG. 2 shows an example cleaning system having an assembly for monitoring the system.

FIGS. 3, 4 and 5 show initial contamination and residual contamination of workpieces detected in the cleaning system.

FIG. 6 shows an example system for determining a dirt particle load in cleaning fluid.

FIG. 7 shows an example system for analyzing initial contamination and residual contamination of workpieces in a cleaning system.

The figures are not to scale. Instead, to clarify multiple layers and regions, the thicknesses of the layers may be enlarged in the drawings. Wherever possible, the same reference numbers will be used throughout the drawing(s) and accompanying written description to refer to the same or similar parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

The examples disclosed herein relate to workpiece cleaning systems. Additionally, the examples disclosed herein relate to a method for monitoring such workpiece cleaning systems and controlling at least one process parameter of the workpiece cleaning systems.

A workpiece, as described herein, may be any object including, for example, a component of a complex system or an assembly composed of a plurality of components. The examples disclosed herein permit industrial cleaning of workpieces while maintaining a high predefined cleaning quality level for relatively large numbers of workpieces.

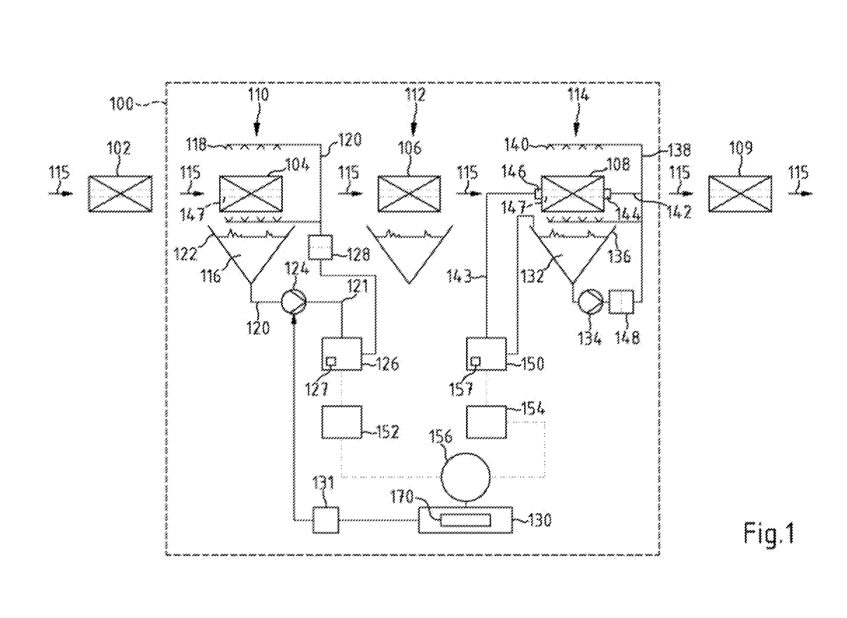

FIG. 1 shows an example cleaning system having a closed-loop control device of a process parameter for a cleaning process in accordance with the teachings of this disclosure. The system 100 of FIG. 1 is integrated in a production line. To clean workpieces 102, 104, 106, 108, the system 100 includes cleaning stations or cleaning sections 110, 112, 114. The workpieces of the illustrated example may be cleaned in the cleaning stations or cleaning sections 110, 112, 114 using a cleaning fluid. In this example, the system 100 includes a conveying device with which the workpieces 102, 104, 106, 108, 110 may be automatically moved through the cleaning stations 110, 112, 114 in a general direction indicated by the arrows 115. Spray nozzles 118 are positioned in the cleaning station 110.

The spray nozzles 118 of the illustrated example are cleaning devices to apply cleaning fluid 116 to the workpiece 102 positioned in the cleaning station 110. In the illustrated example, a collecting container 122 collects the cleaning fluid 116. Dirt particles rinsed off from the workpiece 104 by the cleaning fluid flow together with the cleaning fluid 116 into the collecting container 122 during cleaning of the workpiece 102.

In the illustrated example, the cleaning station 110 includes a fluid circuit with a line system 120 coupled to the collecting container 122. A circulating pump 124 is positioned in the line system 120. The circulating pump 124 of the illustrated example includes an adjustable delivery pressure. Adjusting the delivery pressure allows variation (e.g., adjustment) of the quantity of cleaning fluid 116 emerging from the spray nozzles 118 per unit time (e.g., flow rate adjustment). Additionally, pressure of the cleaning fluid 116 that is applied to a workpiece 104 positioned in the cleaning station 110 may be altered.

In the illustrated example, to set the delivery pressure of the pump 124, the system 100 includes an assembly 130 with a process parameter setting device 131.

The process parameter setting device 131 is coupled to the circulating pump 124. The cleaning fluid 116 is delivered into the line system 120 via the circulating pump 124. In the illustrated example, the cleaning fluid 116 flows to the spray nozzles 118 via a system 126, which determines a dirt particle load in the cleaning fluid used for cleaning the workpiece 104, and a filter device 128. The system 126 of the illustrated example includes a measuring device 127. A variable dependent on the number of dirt particles in the cleaning fluid used to clean a workpiece (e.g., a variable which is proportional to the number of dirt particles present) may be measured with the measuring device 127. In this example, a partial stream of the cleaning fluid provided to the system 126 is directed through the measuring device 127 in the system 126 in order to measure the amount of dirt particles.

In some examples, the measuring device 127 is calibrated to enable the absolute number of dirt particles in a predefined dirt particle size class to be measured in the cleaning fluid used to clean a workpiece. In other words, the measuring device 127 enables determination, for example, of the absolute number of dirt particles in a specific dirt particle size class in the volume of cleaning fluid with which the workpiece 104 has been rinsed in the cleaning station.

To calibrate a measuring device 127, in some examples, the line system 120 includes an injection point 121. A precisely defined quantity of dirt particles are provided via the injection point 121 to the cleaning fluid in the system 126. The dirt particles may be, for example, silicone spheres or metal particles with different sizes. In some examples, a calibration factor may then be determined from the measured value determined by the measuring device 127 of the quantity of dirt particles provided to the system 126 via the injection point 121. The calibration factor allows the measured values of the measuring device to be converted into an absolute number of dirt particles. Additionally, in some examples, providing the dirt particles via the injection point 121 enables functionality (e.g., effectiveness) of the measuring device 126 to be verified. In order to ensure reliable functioning of the measuring device 127, in some examples, it is advantageous for the system 126 to have a volume flow measuring apparatus. This volume flow measuring apparatus detects whether or not cleaning fluid is present (e.g., present to a certain degree) in the measuring device 127, for example. The volume flow measuring apparatus enables detection of a blockage of the flow of cleaning fluid in the measuring device. A corresponding volume flow measuring apparatus also permits a detected proportion of dirt particles to be determined relative a measured volume flow.

The system 100 of the illustrated example contains a device (e.g., sensor) 152 for the continuous detection of initial contamination (e.g., soiling) S₁ of workpieces in the cleaning system 100. In the illustrated example, the device 152 determines the dirt particle load in cleaning fluid 116 with which a workpiece 104 has been cleaned from the nozzles 118 at the beginning of the cleaning process during a specific time interval. Such a determination results from the dirt particles being counted by the device 152 during a specific time interval with a test volume through which cleaning fluid flows. In some examples, in order to prevent dirt particles that adhere firmly to a workpiece 104 from skewing measurements, the initial contamination of workpieces detected by the device 152, it is advantageous to subject the workpiece 104 to measure initial contamination briefly to clean at an increased intensity. This may be achieved, for example, when the cleaning fluid emerging from the nozzles 118 is applied to the workpiece 104 for a specified time. The cleaning fluid of the illustrated example is provided at a relatively high pressure to effectively remove particles that adhere to the workpiece 104.

The device 152, in some examples, determines the cleanliness value according to VDA Guideline 19 and/or ISO Standard 16232 of the workpiece 104 provided to the system 100. The device 152 may be operated in a calibration mode where the device 152 records how many dirt particles are detected in workpieces in which a cleanliness value is known. The number of dirt particles detected with the device 152 of a workpiece (e.g., the number of dirt particles in a specific particle size class) is then subsequently compared to the corresponding cleanliness value. A calibration constant is then determined from this comparison.

The cleaning station 114 of the illustrated example enables cleaning of a workpiece 108 with cleaning liquid 132 provided to spray nozzles 140 via a circulating pump 134 from a collecting container 136 through a line system 138. The line system 138 of the illustrated example also includes a line branch 140 to which the workpiece 108 can be coupled by adapter pieces 144, 146 to clean a bore 147 in the workpiece 108. The workpiece 108 of the illustrated example is clamped between the adapter pieces 144, 146 to allow a relatively tight connection between the line through which the cleaning fluid 132 is provided in and discharged, and the workpiece in the line branch 142.

The line system 138 of the illustrated example also includes a filter device 148. A system 150 for determining a dirt particle load in the cleaning fluid 132 used to clean the workpiece by rinsing the workpiece bore is in the line branch 142 of the line system 138. In the illustrated example, the dirt particle load in the cleaning fluid 132 that flows through the bore 147 of the workpiece 118 may be determined by the system 150. Like the system 126, the system 150 has a measuring device 157 to determine a variable dependent on the number of dirt particles in the cleaning fluid used to clean a workpiece (e.g., a variable that is proportional to the number of dirt particles). In order to calibrate the measuring device 157, an injection point 143 in the line system 140 provides a precisely defined quantity of dirt particles to the cleaning liquid of the system 150.

The system 150 of the illustrated example is coupled to a device (e.g., sensor) 154 to continuously detect a final contamination (e.g., soiling) 52 of workpieces in the cleaning system 100. A dirt particle load of the cleaning fluid 132 conducted for a predetermined time interval via the line branch 142 through the workpiece bore 147 at the end of cleaning of the workpiece 108 in the system 100 may be detected by the device 154. Similar to the device 152, for this determination, the dirt particles are counted in the device 154 during a specific time interval using a test volume through which cleaning fluid flows. The device 154, likewise, enables the determination of a cleanliness value according to the VDA Guideline 19 or the ISO Standard 16232 of a workpiece 108 cleaned in the cleaning station 145. The device 154 may be operated in a calibration mode for this determination. In such a calibration mode, the device 154 of the illustrated example records how many dirt particles are detected of a workpiece in the cleaning station 114 whose cleanliness value is known according to the VDA Guideline 19 or the ISO Standard 16232. The number of dirt particles detected for the workpiece by the device 154, for example, the number of dirt particles of a specific particle size class, is then compared to the corresponding cleanliness value, and a calibration constant is subsequently determined from this comparison. Since the calibration constant of such a determination is subjected to evaluation over a relatively long time, it is also possible to determine (e.g., infer) the change (e.g., change over time) in the effectiveness of the measuring device 127 or 157.

The system 100 of the illustrated example contains a device 156 to continuously detect the successful cleaning of a workpiece which is cleaned in the system, for example. In the illustrated example, the device 156 is coupled to the device 152 to detect initial contamination and to the device 154 to detect final contamination. The device 156 of the illustrated example receives, from the device 152, information determined via the system 126 pertaining to contamination of a workpiece 104 provided to the system 100. The device 156 receives information about the contamination of a workpiece section. For example, information pertaining to contamination of the workpiece bore 147 of the device 154 is received by the device 156 after cleaning of the workpiece in the system 100 is concluded. In the illustrated example, a quantitative variable is determined in the device 156 from the initial contamination and final contamination of a workpiece, where the quantitative variable indicates successful cleaning. However, it is also possible for successful cleaning to be determined by the device 156 by, for example, a difference of the final contamination of a workpiece from a setpoint value. In some examples, to calibrate the device 152 and/or 154, it is possible to specify the successful cleaning in the device 156 on the basis of a cleanliness value for the workpiece that corresponds to the VDA Guideline 19 or the ISO Standard 16232.

The device 156 of the illustrated example is coupled to the assembly 130 with the process parameter setting device 131. In the illustrated example, the computer 170 in the assembly 130 calculates a delivery pressure p for the circulating pump 124 in the cleaning station 110 as a process parameter P from the continuously detected initial contamination S₁ and the continuously detected residual contamination S₂. The process parameter setting device 131 of the illustrated example sets the delivery pressure p for the circulating pump 124 in the cleaning station 110 based on the initial contamination determined by the system 126 of a workpiece 104 provided to the system 100 and the contamination detected with the system 154 of a workpiece section of this workpiece before the workpiece exits the cleaning system 100.

The computer 170 of the illustrated example determines the process parameter P in the form of the delivery pressure p with a functional rule P:=F_{S2}(S₁) (i.e., a function of the initial contamination S₁), which is dependent on the residual contamination S₂, with respect to the initial contamination E1 of a workpiece 104 that corresponds to a closed-loop control circuit that determines the functional rule on the basis of the difference of the detected residual contamination S₂ from a residual contamination setpoint value RS. The assembly 130, thus, acts as a combined open- and closed-loop control device. The functional rule P:=F_{S2}(S₁) is stored here as a characteristic curve diagram in a data memory of the computer 170 to calculate other process parameters P for cleaning workpieces in the system 100 (e.g., the temperature of cleaning fluid or the duration of a rinsing process for a workpiece in a cleaning station 110, 112, 114).

The characteristic curves in such a characteristic curve diagram enable setting contaminated particularly favorable process parameters for the cleaning(e.g., a time period for the cleaning of a workpiece, the temperature of the cleaning fluid used for the cleaning, the chemical composition of the cleaning fluid, the pressure which is applied to the cleaning fluid, etc.) based on the contaminated state or cleanliness state detected from a workpiece. The initial value and final value of a characteristic curve and the steepness thereof are optimized for the cleaning process or processes in the system and for the design of the system. A characteristic curve assigns a suitable pump pressure P for circulating the cleaning fluid in the system 100 to, for example, a specific load detected per time unit in the cleaning fluid of dirt particles associated with a specific particle class.

In some examples, it is possible to provide to the assembly 130 the initial contamination of a workpiece positioned in the cleaning station 110 at the start of cleaning and the final contamination of a workpiece in the cleaning station 114 after cleaning is concluded. Alternatively or additionally, to set the pump pressure p of the circulating pump 104, in some examples, it is possible to regulate other process parameters, such as, for example, a temperature of the cleaning fluid 116, 132 in the cleaning station 110, 112, 114, and/or a chemical composition of the cleaning fluid 116 in a cleaning station 110 with the assembly 130 and the process parameter setting device 131. Alternatively or additionally, in some examples, it may be possible to set the opening cross section of the nozzles 118, 140 in the line systems 120, 138 or the length of the time intervals for a cleaning process in a cleaning station or in a plurality of the cleaning stations 110, 112, 114. Further, in some examples, it may be possible to use the assembly 130 and the process parameter setting device 131 to regulate the intensity of an ultrasonic signal input into cleaning fluid to clean workpieces based on the signal of the closed-loop control device 156. In some examples, it is possible not to operate the assembly 130 as a closed-loop control device but, instead, as an open-loop control device.

In some examples, the system 100 contains sensors with which not only detect a dirt particle load in cleaning fluid, but also detect a turbidity level of the cleaning fluid, a surface tension of the cleaning fluid, a surfactant content in the cleaning fluid and/or a pH value of the cleaning fluid. In some examples, additionally, the system 100 includes sensors to allow the sensing of the surface of workpieces with infrared light to enable detection of grease accumulated on the surface of a workpiece. Since these sensors are coupled to the assembly 130, the process parameters may be set for the cleaning of workpieces in the system 100 to values that are favorable for cleaning based on the measurement variables detected with the above-mentioned sensors. In some examples, it is favorable if, in the system 100, the cleaning of workpieces is controlled as a function of the degree of contamination of cleaned workpieces (i.e., the cleanliness of these workpieces, and/or the degree of contamination of uncleaned workpieces). This measurement enables the cleaning sequence to be optimized in terms of the consumption of energy and/or resources.

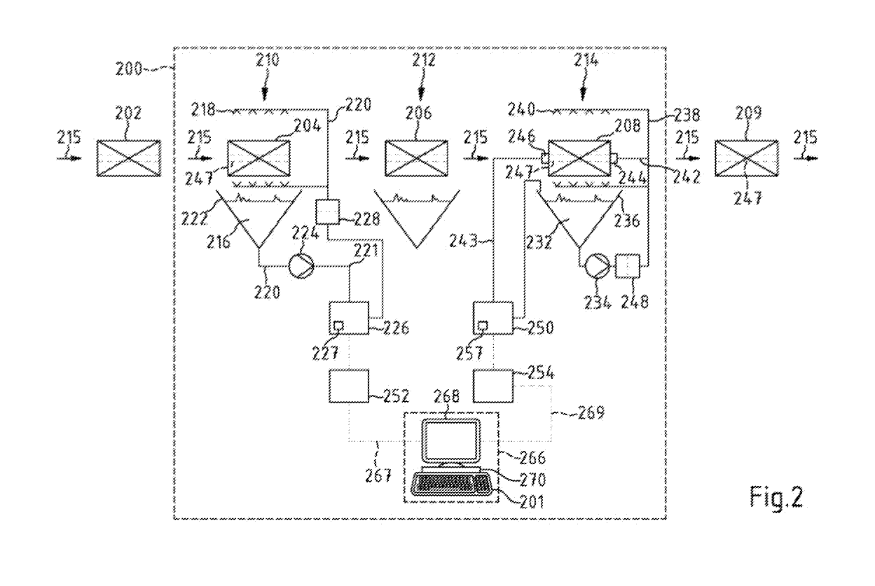

FIG. 2 shows an example cleaning system with an assembly to monitor the system 200. The system 200 of FIG. 2 has a design similar to the design of the system 100. Elements in FIG. 2 whose function is identical to the elements of the system 100 shown in FIG. 1 are therefore indicated in FIG. 2 with reference symbols that are incremented by the number 100 relative to the elements of FIG. 1.

The system 200 of the illustrated example contains an assembly 266, which acts as a control center to control and monitor the cleaning process in the system 200. The process parameters to clean workpieces in the cleaning stations or cleaning sections 210, 212, 214 may be set by the assembly 266. The assembly 266 of the illustrated example is communicatively coupled, via a data transmission link 267, 269, to the device 252 to continuously detect initial contamination S₁ on workpieces, and to the device to continuously detect residual contamination S₂ of workpieces.

The assembly 266 of the illustrated example includes a computer 270 with a computer program to determine system operating states and to determine (e.g., infer) a system malfunction from a determined system operating state. In the illustrated example, the assembly 266 includes a display unit 268 that acts as a warning signal generator and displays a malfunction of the system 200 to an operator. The display of the malfunction in the system 200 by the assembly 266 may function in an operating mode set via an interface 201 with a fault-specific display of a warning signal for a system malfunction determined on the basis of the signals of the devices 252, 254. Additionally or alternatively, in some examples, to display system malfunctions, the display unit 268 may have an acoustic warning signal generator.

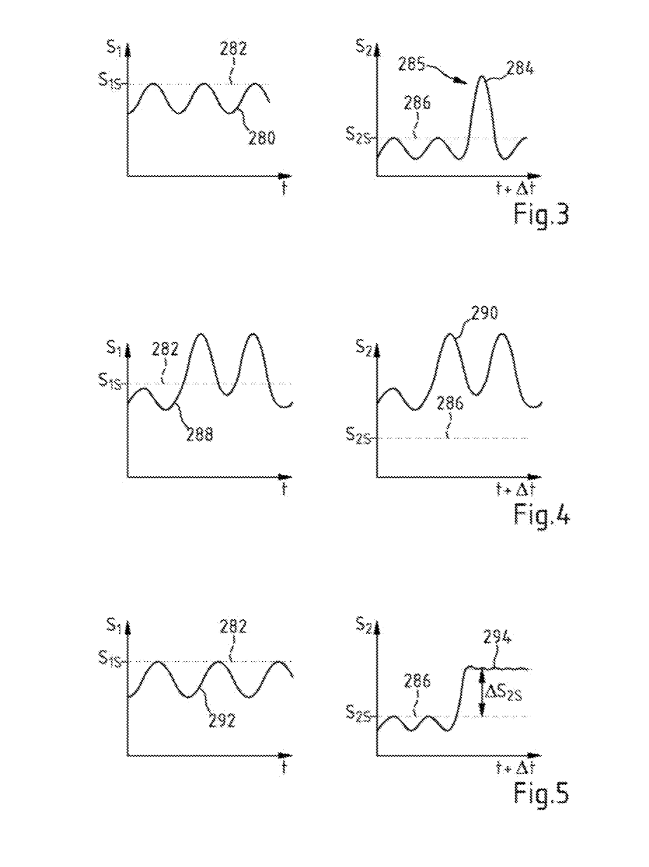

FIGS. 3, 4 and 5 show initial contamination and residual contamination of workpieces detected in the cleaning system. Various methods of functioning of the assembly are described below in connection with FIGS. 3 and 5, which relate to different operating states A, B, C of the system 200, respectively. In the operating state A of FIG. 3, the assembly receives information from the device 252 that the initial contamination detected in a specific time period t corresponding to the curve 280 for workpieces as a dirt particle load S₁ in cleaning fluid with which workpieces are rinsed in the cleaning section 210 before cleaning is below a first predefined setpoint value S_{1S} that corresponds to the straight line 282. Nevertheless, the residual contamination detected by the device 254 at the time t+Δt as the dirt particle load S₂ in cleaning fluid with which workpieces are rinsed in the cleaning section 214 after cleaning is, according to the curve 284 in the section 285, temporarily above a defined second setpoint value S_{2S}. The second setpoint value S_{2S} corresponds to the straight line 286 indicating that a workpiece which is rinsed with cleaning fluid in the cleaning section 214 is contaminated to an excessive degree (i.e., the workpiece was not correctly cleaned).

In the operating state A of the illustrated example, the computer program in the computer 270 of the assembly 266, therefore, causes the fault-specific warning signal display that at least one assembly, used in the cleaning sections 210, 212, 214 to applying cleaning fluid to workpieces is operating incorrectly.

In the operating state B of FIG. 4, the assembly receives from the device 252 information that the dirt particle load S₁ corresponding to the initial contamination in cleaning fluid used for rinsing workpieces 204 is, in a specific time period t corresponding to the curve 288 in FIG. 4, above the predefined setpoint value S_{1S}. The dirt particle load determined with the device 254 at the time t+Δt in cleaning fluid 232 flowing through a workpiece bore formed in a workpiece is above the setpoint value S_{2S} as shown by the curve 290. In this operating state B, the computer program in the computer 270 of the assembly 266 on the display unit 268 generates the fault-specific warning signal display that the initial contamination of a workpiece 202 provided to the system 200 has exceeded a pre-defined limiting value.

In the operating state C of FIG. 5, the assembly 266 receives from the device 252 information that the dirt particle load in cleaning fluid with which workpieces were rinsed in the cleaning section 210 in a specific time period t for determining the initial contamination is below the predefined setpoint value S_{1S} in accordance with the curve 292. Simultaneously, the dirt particle load detected with the device 254 at the time t+Δt in cleaning fluid 232 is, according to the curve 294 with an essentially straight profile 295, continuously above the setpoint value 525 by the absolute value ΔS_{2S}. In this example, displaying the fault-specific warning signal by the computer program in the computer 230 of the assembly 266 causes the filter device 248 in the system 200 to operate incorrectly.

Since the assembly 266 records the information regarding initial contamination, final contamination and/or cleanliness of workpieces cleaned in the system 200 over a relatively long time period, it is, for example, possible to determine the quality of cleaning fluid and of rinsing baths or cleaning baths in the system, the chemical composition of cleaning fluid and the function of filter stages in the system, the loading of the system with dirt particles and/or the function of assemblies of the system. In this example, since the initial contamination of workpieces is determined, detection may be possible as to whether the contamination of a respective workpiece can be removed at all within a time window provided for cleaning in the system. Additionally, in some examples, the detection of the initial contamination of workpieces permits maintenance intervals to be predicted for certain assemblies of the system (e.g., for filter and bath liquids). In some examples, it is possible for the assembly 266 to generate a warning signal and trigger suitable control processes if the degree of contamination of workpieces that are provided to the system 200 is outside an adjustable tolerance range.

In some examples, a system according to the examples disclosed with an assembly may allow for process parameters such as in the case of the system 100 described in FIG. 1 based on successful cleaning detected by the devices 152, 154 with a closed-loop control device.

Additionally, in some examples, a cleaning system according to the examples disclosed may be configured with one or more cleaning sections. In some examples, the cleaning process in a cleaning system may also be multi-stage. It is, for example, favorable if, in a first stage, coarse contamination is cleaned off and then in one or more additional stages following the first stage a cleaning result for a workpiece is improved. Since cleaning fluid which is used in the last, concluding cleaning process must then only contain a small amount of dirt particles for satisfactory functioning of the system, it is possible, in this way, to detect a degree of contamination or of cleanliness of workpieces.

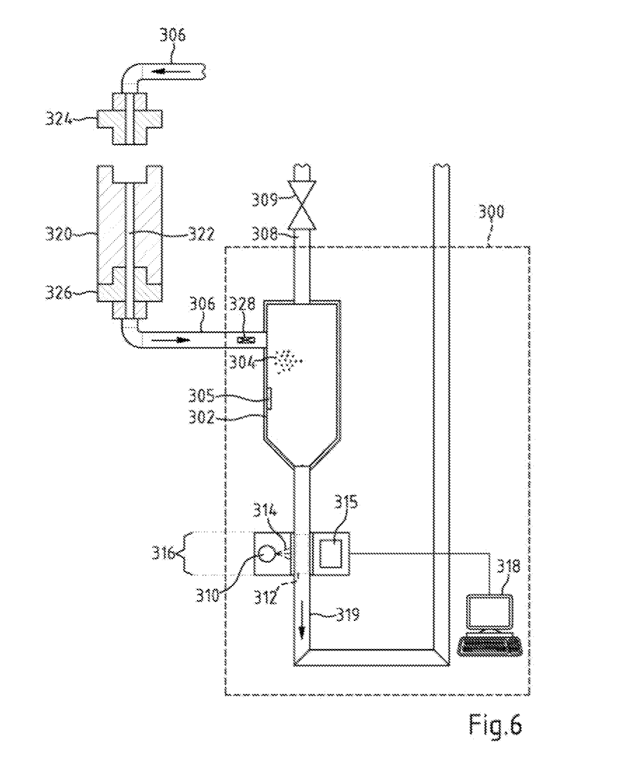

FIG. 6 shows an example system 300 to determine a dirt particle load in cleaning fluid. FIG. 6 shows the system 300 as a possible example for a system 126, 150, 226, 250 in the systems 100 and 200 of FIGS. 1 and 2. The system 300 of the illustrated example includes a buffer container 302, which is a hydrocyclone and to which fluid 304 loaded with dirt particles is provided from a line section 306. The buffer container 302 of the illustrated example includes a feedback connection 308 with a valve 309 through which cleaning fluid 304 may be provided to the buffer container 302, or through which cleaning fluid 304 from the buffer container 302 may be discharged. The buffer container 302 opens into a pipe line 318 through which the cleaning fluid 304 may be provided back into a circuit for cleaning fluid of a system. The cleaning fluid that is loaded with dirt particles is degassed in the buffer container 302 (i.e., air bubbles are removed). For degassing, the buffer container 302 includes a device 305 to input ultrasonic sound into the cleaning fluid, which has collected. Alternatively, to degas cleaning fluid may be degassed in the buffer container 302 and/or an underpressure or an overpressure may be applied relative to the atmospheric pressure to the cleaning fluid collected.

The system 300 of the illustrated example includes a measuring device with an optical particle counter. The optical particle counter includes a light source 310 for generating light beams 314 to penetrate a test volume 312 with cleaning fluid 304, for example. The light beams 314 that penetrate the test volume 314 are directed to an optical sensor 315, which detects the intensity of the light beams 314. The system 300 of the illustrated example has the test volume 312 in a section 316, which is a glass pipe of the pipe line 319 transparent to light generated by the light source 310. In an example evaluation unit, a dirt particle load in cleaning fluid moved through the pipe line 306 can be detected here on the basis of the intensity at the optical sensor 316 to detect the intensity of the light beams 314 that penetrate the test volume 312.

The light source 310 of the illustrated example is mounted to enable the light 314 to illuminate the cleaning fluid that is provided into the test volume 312. The dirt particles that are carried in the cleaning fluid scatter and/or absorb this light. The dirt particles, thus, form shadows at the optical sensor 315. The effect of light and dark regions on the optical sensor in combination with a computer 318 permits the size of dirt particles carried along in the cleaning fluid to be measured and/or the number of dirt particles to be determined. These measured values of the illustrated example are then provided to the device 156 in the system 100 or the assembly 266 in the system 200. The buffer container 302 of the illustrated example in the system 300 acts as a device to remove air bubbles from the cleaning fluid to ensure that the optical sensor 315 does not generate incorrect signals.

In the illustrated example, a workpiece 320 may be positioned in the line section 306 to clean a bore 322 formed therein and to detect the contaminated state of the bore 322 of the workpiece 320 before or after cleaning. In the illustrated example, there are adapter pieces 324, 326 located in the line section 306. The adapter pieces 324, 326 of the illustrated example may be coupled to the workpiece 320 with a sealing interface to ensure that the bore 322 of the workpiece 320 may be cleaned with cleaning fluid to which a high pressure is applied. Such a measure also enables the contaminated state of the workpiece or the successful cleaning achieved for the workpiece 320 to be precisely determined from a dirt particle load in cleaning fluid conducted flowing a bore 322 in the workpiece 320.

The system 300 of the illustrated example includes a volume flow measuring apparatus 328 that enables the number of dirt particles to be determined by the computer 318 to be related to a cleaning fluid flow provided to the system 300 from the workpiece 320. For example, such a volume measuring apparatus 328 permits a potential malfunction of the system 300 to be detected when one or more of the pipe lines 306, 319 is blocked.

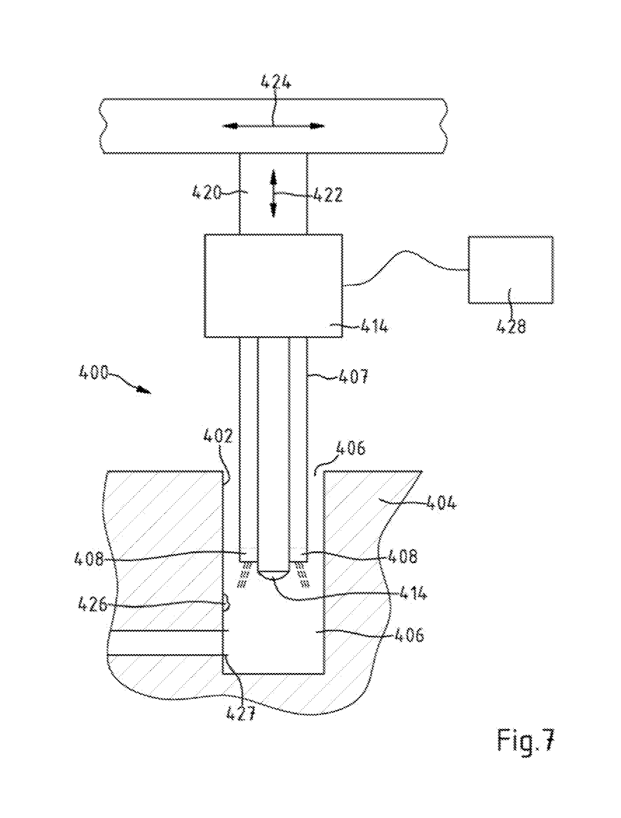

FIG. 7 shows an example system 400 for analyzing initial contamination and residual contamination of workpieces in a cleaning system. The system 400 of the illustrated example is that which the successful cleaning of a workpiece cleaned in a cleaning system or initial contamination and residual contamination of a workpiece may be determined. The system 400 of the illustrated example is a measuring device that includes an imaging system for the optical sensing of a surface 402 of a workpiece bore 404. The system 400 may be used, for example, before cleaning in a cleaning station of a system, during cleaning in a system or after cleaning. The system 400 of the illustrated example includes an endoscope probe 407 that can be placed in a workpiece bore 406. The endoscope probe 407 of the illustrated example includes a light source 408 with which the wall 410 of the workpiece bore 404 can be illuminated. In the illustrated example, the endoscope probe 407 includes a wide angle lens 414 with an optical system that projects the wall 410 of the workpiece bore 406 onto the light sensor 416 of a camera coupled to an evaluation computer 428. In some examples, to enable the endoscope probe 407 to be moved in relation to the workpiece 404, the endoscope probe 407 is positioned on a positioning unit 420 that moves the endoscope probe 407 in a general direction indicated by the double arrows 422, 424.

The light source 408 of the illustrated example is positioned on the endoscope probe 407 such that the wall 402 of the bore 406 is illuminated according to the grazing light principle. Particles 426 and burr 427 located on the bore wall 402 form a contrast between particles and bore surface. The structures of the dirt particles 426 and the burr 427 on the bore wall 402 can, therefore, be optically detected. While the endoscope probe 411 is moved into the bore 406, the wide angle lens 414 located at the front end of the endoscope probe 411 takes an image of the wall 402 of the bore 406 and the camera records the image. In the illustrated example, to detect the dirt particles 426 and burr 427, a contrast determination of the overall image of the surface 402 of the workpiece bore 406 occurs in the computer unit 428. Based on this contrast, a computer program stored in the computer unit 428 then calculates an image of the particles 426 and burr 427. The computer unit 428, in some examples, determines the particle size on this basis. The number of particles 426 and burr 427 as well as the size thereof for each tested bore 406 may then be provided to the analysis device 156 of the system 100 or the control center 266 of the system 200.

Additionally, to determine the contamination of workpieces, in some examples, a system to detect dirt particles in cleaning fluid includes an inductive measuring device. In some examples, such an inductive measuring device has one or more field coils and comprises at least one sensor coil for inductively detecting metallic particles. Such inductive measuring devices allow precise detection of metal dirt particles and/or numerous dirt particles.

A field coil in an inductive measuring device used to generate an alternating magnetic field that penetrates a fluid flow and is conducted through a line section of the measuring device. To accomplish this, the field coil is coupled to a high-frequency voltage source. The alternating magnetic field is applied to metallic and magnetic dirt particles in the fluid flow. These dirt particles influence the inductive coupling of the respective field coil to the at least one exciter coil. Based on the voltage induced in the at least one sensor coil with the at least one field coil, it is possible to determine the number and size of dirt particles moving through the line section of the measuring device. By using sensor coils that are wound in opposite directions to one another and spaced apart from one another, it is possible to comparatively detect small and nonmagnetic particles (e.g., particular particles made of aluminum) in the cleaning fluid.

Additionally or alternatively, the quantity of dirt particles in cleaning fluid may be determined by an extinction measuring device. Similar to an inductive measuring device, an extinction measuring device may also be advantageously used in a system according to the examples disclosed herein.

The measuring devices described above are suitable, in some examples, to determine the initial contamination of workpieces in a cleaning system. These measuring devices, in some examples, have an effective cross section of fluid flow that is significantly large such that even a comparatively large or dense dirt particle load, which may occur frequently at the start of a cleaning process, does not block the measuring device. In contrast, to allow for turbidity of cleaning liquid, measuring devices with optical particle counters such as the example described in connection with FIG. 6, does not typically have the same effective cross section because having the same effective cross section may result in insufficient sensitivity. Additionally, in such examples with measuring devices having optical particle counters, air bubbles detected with dirt particles result in incorrect measurements. In some examples, the following described features are preferred. Such examples relate to a system 100, 200 to cleaning workpieces 102, 104, 106, 202, 204, 206. The system, for example, contains a cleaning device cleaning device 118, 144, 146, 218, 240 to apply cleaning fluid to a workpiece 104, 106, 204. In some examples, the system 100, 200 have a device 154, 254 to detect a first contamination status S₁ of initial contamination of a workpiece 104, 204 before cleaning in the system, and/or a device 152, 254 to detect a second contaminated state S₂ in the form of residual contamination S₂ of a workpiece 108, 208 cleaned in the system, and an assembly 130, 266 that determines a system operating status A, B, C and/or sets at least one process parameter P of a cleaning process in the system as a function of a first and/or second contaminated state S₁, S₂ detected for workpieces 108, 208. In order to clean, the system 100, 200 may have one or more cleaning stations 110, 112, 114, 210, 212, 214 with a cleaning device 118, 140. In some examples, the system includes a device 152, 252 to preferably continuously detect initial contamination S₁ of workpieces 104, 204 provided to at least one cleaning station 110, 112, 114, 210, 212, 214, before cleaning, and/or a device 154, 254 to preferably continuously detect residual contamination S₂ of workpieces 108, 208 after cleaning in at least one cleaning station 110, 112, 114, 210, 212, 214. The system 100, 200, in some examples, includes an assembly 130, 266 to monitor the system operating state, of which the assembly 130, 266 is coupled to the device 152, 252 to preferably continuously detect initial contamination S₁ and/or to the device 154, 254 to preferably continuously detect residual contamination S₂. The assembly 130, 266 includes a computer 170, 270 to determine a system operating state A, B, C based on the preferably continuously detected initial contamination S₁ and/or the preferably continuously detected residual contamination S₂ and/or calculates the at least one process parameter P to clean workpieces 104, 106, 108 in the system 100 based on the preferably continuously detected initial contamination S₁ and/or the preferably continuously detected residual contamination S₂.

The examples disclosed herein permit industrial cleaning of workpieces with a continuous high preset cleaning quality for large quantities of workpieces.

The examples disclosed herein allow development of a system to clean workpieces with an assembly to monitor a system operating state that is coupled to a device to, in some examples, preferably continuously detect the initial contamination of workpieces provided to the system or cleaning stations in the system, and, in some examples, preferably continuously detect residual contamination of workpieces cleaned in the system or in a cleaning station in the system.

In some examples, the detection of the initial contamination and/or the detection of the residual contamination of workpieces takes place not only at regular or irregular intervals but also in a punctiform fashion in a single sample or continuously, for example.

The communicative coupling of the assembly to the device for preferably continuously detecting initial contamination and continuously detecting residual contamination may be implemented not only as a wired (e.g., galvanic connection) but also as a wireless connection, for example as a radio connection. It has been found that with such a measure, whether a system for cleaning workpieces is operating incorrectly can be very quickly detected.

Some example assemblies contain a computer that determines a system operating state from the preferably continuously detected initial contamination and the preferably continuously detected residual contamination. Some examples have a warning signal generator to display a system malfunction derived from the determined system operating status in the computer, operators in an industrial fabrication system may safely and reliably cause a determined system malfunction to be displayed.

Such examples also permit, for example, a trend analysis of the contamination of workpieces in a continuous fabrication process. Additionally, such examples permit detection workpieces processing occurring before cleaning with tools that are incorrect and are, therefore, highly contaminated or are loaded with dirt particles (e.g., swarf, particles with a characteristic swarf form, etc.).

In some examples, the computer determines the system operating status from a continuous comparison of initial contamination of workpieces with a first threshold value and of final contamination of workpieces with a second threshold value. For example, the computer concludes a system malfunction when the continuously determined initial contamination undershoots the first threshold value, the continuously determined final contamination exceeds the second threshold value, if the continuously determined initial contamination exceeds the first threshold value and the continuously determined final contamination exceeds the second threshold value, and/or the continuously determined final contamination remains substantially constant for successive workpieces and continuously exceeds the second threshold value with an absolute value that remains substantially constant.

In some examples, the assembly includes a computer that calculates at least one process parameter of a cleaning process in the system from the continuously detected initial contamination and the continuously detected residual contamination, in which the at least one process parameter is then set by the assembly in order thereby to achieve a desired cleaning quality of workpieces cleaned in the system.

According to the examples disclosed herein, the detection of the initial contamination and/or the detection of the residual contamination of workpieces may occur not only at regular or irregular intervals, but also in a punctiform pattern in the manner of a sample, or continuously, as an alternative.

The examples disclosed herein enable operation of a cleaning system with variable process parameters where the process takes into account the degree of contamination of workpieces.

In some examples, it is advantageous if the computer calculates the process parameter as a function of the preferably continuously detected initial contamination with a functional rule that is dependent on the preferably continuously detected residual contamination. It has been realized that cleaning quality which stays the same and is largely independent of the initial contamination of workpieces may be ensured by the computer determining the functional rule, which is dependent on the residual contamination, with a closed-loop control circuit on the basis of a deviation of the detected residual contamination from a residual contamination setpoint value. This functional rule is stored, for example, in a data memory of the computer as a characteristic curve diagram.

The assembly may therefore set the at least one process parameter, for example, as a function of a successful cleaning that is detected by a device to detect (e.g., sensor) residual contamination of a workpiece cleaned in the system and a device for detecting initial contamination of a workpiece, before cleaning.

The successful cleaning as described herein is a deviation of residual contamination detected for a workpiece from a setpoint value, or a variable which is determined from the initial contamination and the residual contamination of a workpiece.

The at least one process parameter can be, for example, the temperature of the cleaning fluid in the cleaning section and/or the chemical composition of the cleaning fluid (e.g., the proportion of acids and/or lyes and/or surfactants in the cleaning fluid). Additionally or alternatively, the process parameter is, for example, the pressure of the cleaning fluid in the cleaning section and/or the volume flow to a workpiece in the cleaning section. The process parameter, in some examples, is approximately the length of a time interval for which cleaning fluid is applied to a workpiece and/or the intensity of an ultrasonic signal that is provided into the cleaning fluid to clean a workpiece.

In some examples, the device for detecting residual contamination of a workpiece cleaned in the system or detecting initial contamination of a workpiece before cleaning may have an imaging system to optically detect a surface of a workpiece. Such an imaging system serves to examine a workpiece surface before the workpiece is cleaned in the cleaning station, during cleaning or after cleaning. In some examples, the analyzing device preferably includes a computer unit and a computer program to detect dirt particles on the surface of the workpiece. To detect dirt particles, the computer program may be configured, for example, to evaluate the contrast of a workpiece surface.

The imaging system includes, for example, an endoscope probe that can be positioned in workpiece bores. This endoscope probe, in some examples, preferably has a light source to illuminate a wall of the workpiece bore. In some examples, it advantageous to have a wide angle lens to optically image such a wall on a light sensor in the endoscope probe. In some examples, a positioning device for the endoscope probe, which can be moved in relation to a workpiece, is advantageous.

In some examples, the device for detecting initial contamination and/or residual contamination of workpieces includes a system to determine a dirt particle load in cleaning fluid used to clean a workpiece by rinsing. In some examples, the system includes a light source that generates light beams penetrating a test volume in which cleaning fluid is located. In some examples, the dirt particle load of the cleaning fluid in the test volume is detected with an optical sensor to detect the intensity of the light beams penetrating the cleaning fluid test volume.

In some examples, to allow the light source and the sensor to be positioned outside a power system, it is favorable for the line system conducting cleaning fluid with a line section that is at least partially transparent to light beams.

In some examples, to prevent incorrect signals in a system to determine dirt particle load of cleaning fluid, it is advantageous to have a device to remove air bubbles from cleaning fluid flowing through the light beam. Such a device may be, for example, a buffer container in which an ultrasonic probe is positioned or in which an underpressure or an overpressure compared to the atmospheric pressure is applied to the cleaning fluid.

In the example systems disclosed to clean workpieces, the cleaning of the workpiece is repeated as a function of a detected contaminated state, cleanliness state of a workpiece cleaned in the system and/or of a detected contaminated state or cleanliness state of a workpiece provided to the system, and, if appropriate, is repeated. The example systems disclosed, for this purpose, contain a device which, as a function of the detected contaminated state of a workpiece cleaned in the system and/or of a workpiece before cleaning in the system, releases the workpiece after a cleaning process in the system or feeds the workpiece to the system again in order to repeat the cleaning process of the workpiece.

In a method in accordance with the examples disclosed herein, cleaning fluid is applied to workpieces one after the other in a sequential fashion in a cleaning station. In this context, the contaminated state of a workpiece that is cleaned in the system or in a cleaning station in the system and/or a contaminated state of a workpiece before cleaning in the system or in a cleaning station of the system is preferably detected continuously in order to subsequently set at least one process parameter P of a cleaning process as a function of the detected contaminated state.

In some examples, the degree of successful cleaning that occurs with a workpiece is determined. In such examples, at least one process parameter for the optimized cleaning of a workpiece following the analyzed workpiece in the cleaning station is set as a function of the successful cleaning determined for a workpiece. In some examples, successful cleaning is understood to be a difference between final contamination detected for a workpiece and a setpoint value or a variable that is determined from the initial contamination and final contamination of a workpiece, and is preferably a quantitative measure.

In some examples, such a process parameter for optimized cleaning may be, for example, the temperature of the cleaning fluid in the cleaning station, the chemical composition of the cleaning fluid, the pressure of the cleaning fluid in a cleaning station and/or the volume flow thereof. A process parameter may, alternatively or additionally, be the length of a time interval for the cleaning and/or the intensity of an ultrasonic signal inputted into the cleaning fluid for workpiece cleaning. A process parameter for the optimized cleaning may also be a number of workpieces provided to the system per time unit.

In some examples, to determine contamination or cleanliness of workpieces, for example, a dirt particle load that is adhering to a surface of the workpiece may be determined. Additionally, in some examples, it is possible to detect such contamination or cleanliness by determining a dirt particle load, for example, with an optical or an inductive measuring method, in which cleaning fluid has been applied to the workpiece.

In some example methods in accordance with the examples disclosed to monitor a system to cleaning workpieces in a cleaning station, a value for a dirt particle load, a surfactant content and/or a pH value in a test volume of a cleaning fluid used to rinse a workpiece is continuously determined by a measuring device. In some examples, a system malfunction may then be inferred from a comparison of the continuously determined value with a threshold value.

As set forth herein, an example system 100, 200 for cleaning workpieces 102, 104, 106, 202, 204, 206 includes at least one cleaning station 210, 212, 214 that includes a cleaning device 218, 240, a cleaning device 118, 144, 146, 218, 240 for applying a cleaning fluid 116, 132 to a workpiece 104, 106, 204, a device 152, 252 for detecting initial contamination S₁ of workpieces 204 provided to the at least one cleaning station 210, 212, 214, before cleaning, a device 154, 254 for detecting residual contamination S₂ of workpieces 208 after the cleaning in the at least one cleaning station, and a computer 170, 270 that is coupled to the device 152, 252 for detecting initial contamination S₁ and to the device 154, 254 for detecting residual contamination S₂. The computer 170, 270 determines a system malfunction from a continuous comparison of the initial contamination S₁ with a first threshold value S_{1S} and from a continuous comparison of the final contamination S₂ with a second threshold value S_{2S}, where a system malfunction is determined if the continuously determined initial contamination S₁ undershoots the first threshold value S_{1S} and the continuously determined final contamination S₂ exceeds the second threshold value S_{2S}, if the continuously determined initial contamination S₁ exceeds the first threshold value S_{1S} and the continuously determined final contamination S₂ exceeds the second threshold value S_{2S}, and/or if the continuously determined final contamination S₂ remains essentially the same (e.g., substantially constant) for successive workpieces 108, 208 and exceeds the second threshold value S_{2S} continuously with an absolute value ΔS_{2S} that remains substantially constant.

In some examples, the computer 270 is coupled to a warning signal generator 268 to display a determined system malfunction. In some examples, the computer calculates and sets, on based on the initial contamination S₁ detected for workpieces and the detected residual contamination S₂ with a functional rule P:=F_{S2}(S₁) dependent on the initially detected residual contamination S₁ and the continuously detected residual contamination S₂, a system process parameter P in the form of a temperature of a cleaning fluid 116 that is applied to workpieces 104, 204, a chemical composition of a the cleaning fluid 116, the pressure p of the cleaning fluid 116, a volume flow of the cleaning fluid 116, a duration of a time interval in which workpieces 104, 204 are subjected to a cleaning process in a cleaning station 110, an intensity of an ultrasonic signal inputted into the cleaning fluid 116 to clean a workpiece 102, 104, 106, and/or the number of workpieces 102, 104, 106 provided to the system per unit time.

Another example system 100, 200 for cleaning workpieces 102, 104, 106, 202, 204, 206 includes at least one cleaning station 210, 212, 214 that includes a cleaning device 218, 240, a cleaning device 118, 144, 146, 218, 240 for applying a cleaning fluid 116, 132 to a workpiece 104, 106, 204, a device 252 for detecting initial contamination S₁ of workpieces 204 provided to the at least one cleaning station 210, 212, 214 before cleaning, a device 254 for detecting residual contamination S₂ of workpieces 208 after cleaning in the at least one cleaning station, and a computer 277 that is coupled to the device 252 for detecting initial contamination S₁ and to the device 254 for detecting residual contamination S₂. The computer of the example system calculates and sets, on the basis of the initial contamination S₁ detected for the workpieces and the detected residual contamination S₂, a functional rule P:=F_{S2}(S₁) dependent on the continuously detected initial contamination S₁ and the continuously detected residual contamination S₂, a system process parameter P in the form of the temperature of the cleaning fluid 116 that is applied to workpieces 104, 204, a chemical composition of the cleaning fluid 116, the pressure p of the cleaning fluid 116, a volume flow of the cleaning fluid 116, a duration of a time interval in which workpieces 104, 204 are subjected to a cleaning process in a cleaning station 110, an intensity of an ultrasonic signal inputted into the cleaning fluid 116 to clean a workpiece 102, 104, 106, and/or the number of workpieces 102, 104, 106 provided to the system per time unit.

In some examples, the computer 170, 270 determines, on the basis of a continuous comparison of the initial contamination S₁ with a first threshold value S_{1S} is and a continuous comparison of the final contamination S₂ with a second threshold value S_{2S}, a system malfunction. If the continuously determined initial contamination S₁ undershoots the first threshold value S_{1S} and the continuously determined final contamination S₂ exceeds the second threshold value S_{2S} and/or if the continuously determined initial contamination S₁ exceeds the first threshold value S_{1S} and the continuously determined final contamination S₂ exceeds the second threshold value S_{2S}, and/or if the continuously determined final contamination S₂ remains essentially the same for successive workpieces 108, 208 and continuously exceeds the second threshold value S_{2S} with an absolute value ΔS_{2S} that remains substantially constant, a system malfunction is determined.

In some examples, the computer 270 is coupled to a warning signal generator 268 for displaying a determined system malfunction. In some examples, the computer 170 determines the functional rule P:=F_{S2}(S₁), which is dependent on the continuously detected initial contamination S₁ and the residual contamination S₂, with a closed-loop control circuit on the basis of a deviation of the detected residual contamination S₂ from a residual contamination setpoint value RS, and/or in that the functional rule P:=F_{S2}(S₁) is stored as a characteristic curve diagram in a data memory of the computer. In some examples, the device 152, 252 to detect initial contamination S₁ and/or the device 154, 254 to detect residual contamination determine/determines a dirt particle load in a test volume 312 of a measuring device 227 of a cleaning fluid that is used for rinsing a workpiece 104, 108, 204, 208 in a cleaning section 110, 210, 114, 214. In some examples, the device 154, 254 to detect residual contamination S₂ and/or the device 152, 252 to detect initial contamination S₁ includes an imaging system 400 to optically detect a surface 402 of a workpiece 404, and contains a computer unit 428 with a computer program for detecting dirt particles 426, 427 on the surface 402 of the workpiece 404 by evaluating a contrast of the workpiece surface 402.

In some examples, the imaging system 400 includes an endoscope probe that can be positioned in workpiece bores, which includes a light source 408 to illuminate the wall 412 of the workpiece bore 406 and includes a wide angle lens 414 to optically image the wall 412 of the workpiece bore 406 on a light sensor 408. In some examples, the system 400 also includes a positioning device 420 for moving the endoscope probe 407 in relation to a workpiece 404.

Any of the example systems above may include a transporting device which is coupled to the computer 130, 270 and which, as a function of the initial contamination S₁ detected for a workpiece 104, 204 by the computer 130, 270 and/or of the residual contamination S₂ detected of a workpiece 108, 208, either releases the workpiece 109, 209 to a system output after a cleaning process in the system 100, 200 or feeds it to a system input in order to repeat cleaning of the workpiece 108, 208 within the system.

In any of the example systems above, the device 252 to continuously detect initial contamination S₁ of workpieces 204 provided to the at least one cleaning station 210, 212, 214 before cleaning, and/or the device 254 to continuously detect residual contamination S₂ of workpieces 208 after cleaning in the at least one cleaning station 210, 212, 214, contains a system 300 to determine a dirt particle load in cleaning fluid that is used for cleaning a workpiece by rinsing.

In some examples, the device 252 to continuously detect initial contamination S₁ of workpieces 204 provided to the at least one cleaning station 210, 212, 214 before cleaning, and/or the device 254 to continuously detect residual contamination S₂ of workpieces 208 after cleaning in the at least one cleaning station 210, 212, 214, contains a system 300 to determine a dirt particle load in cleaning fluid used to clean a workpiece by rinsing. In some examples, the system 300 includes a light source 310 to generate light beams 314 penetrating a test volume 312 containing cleaning fluid, and includes an optical sensor 315 to detect the intensity of the light beams 314, and/or the system 300 includes a device 302, 305 to remove air bubbles from cleaning fluid provided to the test volume 312, and/or the system includes an inductive measuring device to detect dirt particles in the cleaning fluid.

One example method for monitoring a system 200 to clean workpieces 202, 204, 206 may use any of the example systems above includes detecting initial contamination S₁ of workpieces 204 before cleaning, and detecting residual contamination S₂ of workpieces 208 after cleaning. The example method also includes determining a system malfunction from a continuous comparison of the initial contamination S₁ with a first threshold value S_{1S} and from a continuous comparison of the final contamination S₂ with a second threshold value S_{2S}, if the continuously determined initial contamination S₁ undershoots the first threshold value S_{1S} and the continuously determined final contamination S₂ exceeds the second threshold value S_{2S}, if the continuously determined initial contamination S₁ exceeds the first threshold value S_{1S} and the continuously determined final contamination S₂ exceeds the second threshold value S_{2S}, and/or if the continuously determined final contamination S₂ remains essentially the same for successive workpieces 208 and exceeds the second threshold value (S_{2S}) continuously with an absolute value ΔS_{2S} that remains substantially constant.

Another example method is disclosed for performing open-loop and/or closed-loop control of at least one process parameter P for cleaning workpieces 102, 104, 106 in a system 100 of an example system as described above includes detecting initial contamination S₁ of workpieces 104 provided to the system before cleaning and detecting residual contamination S₂ of workpieces 108 after cleaning. The example method also includes determining, on the basis of the initial contamination S₁ detected for the workpieces and the detected residual contamination S₂ with a functional rule P:=F_{S2}(S₁) dependent on the continuously detected initial contamination S₁ and the continuously detected residual contamination S₂, a system process parameter P in the form of a temperature of a cleaning fluid 116 which is applied to workpieces 104, 204, a chemical composition of the cleaning fluid 116, a pressure p of the cleaning fluid 116, a volume flow of the cleaning fluid 116, a duration of a time interval in which workpieces 104, 204 are subjected to a cleaning process in a cleaning station 110, an intensity of an ultrasonic signal inputted into the cleaning fluid 116 to clean a workpiece 102, 104, 106, and/or a number of workpieces 102, 104, 106 provided to the system per unit time.

Another example system for cleaning workpieces 102, 104, 106, 202, 204, 206 includes a cleaning device (e.g., a cleaning device 118, 144, 146, 218, 240) to apply a cleaning fluid 116, 132 to a workpiece 104, 106, 204 includes a device 154, 254 to detect a first soiled state S₁, for example, in the form of initial contamination of a workpiece 104, 204 before cleaning in the system, and/or a device 152, 254 to detect a second soiled state S₂, for example, in the form of residual contamination S₂ of a workpiece 108, 208 cleaned in the system, and an assembly 130, 266 that determines a system operating status A, B, C and/or sets at least one process parameter P of a cleaning process in the system as a function of a first and/or second soiled state S₁, S₂ detected for workpieces 108, 208.

In some examples, the example system also includes a device 252 to detect initial contamination S₁ of workpieces 204 provided to the at least one cleaning station 210, 212, 214 before cleaning, and a device 254 to detect residual contamination S₂ of workpieces 208 after cleaning in the at least one cleaning station and an assembly 266 to monitor the system operating state. The assembly 266 is coupled to the device 252 to detect initial contamination S₁ and to the device 254 to detect residual contamination S₂, wherein the assembly 266 includes a computer 270 to determine a system operating state A, B, C from the detected initial contamination S₁ and the detected residual contamination S₂.

In some examples, the assembly 266 includes a warning signal generator 268 to display a system malfunction derived from the determined system operating state in the computer 270. In some examples, the computer 270 determines the system operating state A, B, C from a continuous comparison of the initial contamination S₁ with a first threshold value S_{1S} and of the final contamination S₂ with a second threshold value S_{2S}. In some examples, the computer 270 determines a system malfunction if the continuously determined initial contamination S₁ undershoots the first threshold value S_{1S} and the continuously determined final contamination S₂ exceeds the second threshold value S_{2S}, if the continuously determined initial contamination S₁ exceeds the first threshold value S_{1S} and the continuously determined final contamination S₂ exceeds the second threshold value S_{2S}, and/or if the continuously determined final contamination S₂ remains essentially the same for successive workpieces 208 and continuously exceeds the second threshold value S_{2S} with an absolute value ΔS_{2S} which remains essentially the same.

In some examples, the assembly 130 includes a computer 170 that calculates the at least one process parameter P from the continuously detected initial contamination S₁ and the continuously detected residual contamination S₂.

Another example system to clean workpieces 102, 104, 106 includes at least one cleaning station 110, 112, 114 that includes a cleaning device 118, 140 including a device 152 to detect initial contamination S₁ of workpieces 104 provided to the at least one cleaning station 110 before cleaning, a device 154 to detect a residual contamination S₂ of workpieces 108 after the cleaning in the at least one cleaning station 110, 112, 114, and an assembly 130 to set at least one process parameter P of a cleaning process in the system. The assembly 130 is coupled to the device 152 to detect initial contamination S₁ of workpieces 104 provided to the at least one cleaning station 110, 112, 114 before cleaning in the system, and to the device 154 to continuously detect residual contamination S₂ of workpieces 108 after cleaning in the at least one cleaning station 110, 112, 114. The assembly 130 includes a computer 170 that calculates the at least one process parameter P from the detected initial contamination S₁ and the detected residual contamination S₂.

In some examples, the computer 170 calculates the process parameter P as a function of the continuously detected initial contamination S₁ with a functional rule P:=F_{S2}(S₁) that is dependent on the continuously detected residual contamination S₂ and the continuously detected initial contamination S₁. In some examples, the computer 170 determines the functional rule P:=F_{S2}(S₁), which is dependent on the residual contamination S₂, with a closed-loop control circuit on the basis of a deviation of the detected residual contamination S₂ from a residual contamination setpoint value RS, and/or the functional rule P:=F_{S2}(S₁) is stored as a characteristic curve diagram in a data memory of the computer.

In some examples, the at least one process parameter P comprises one or more system operating parameters including temperature of a cleaning fluid 116 that is applied to workpieces 104, 204, chemical composition of the cleaning fluid 116, pressure p of the cleaning fluid 116, volume flow of cleaning fluid 116, length of a time interval in which workpieces 104, 204 are subjected to a cleaning process in a cleaning station 110, intensity of an ultrasonic signal inputted into the cleaning fluid 116 to clean of a workpiece 102, 104, 106, and/or number of workpieces 102, 104, 106 provided to the system per time unit.

In some examples, the device 152, 252 to detect initial contamination (S₁) and/or the device 154, 254 to detect residual contamination determines a dirt particle load in a test volume 312 of a measuring device 227 of a cleaning fluid that is used to rinse a workpiece 104, 108, 204, 208 in a cleaning section 110, 210, 114, 214. In some examples, the device 154, 254 to detect residual contamination S₂ and/or the device 152, 252 for detecting initial contamination S₁ includes an imaging system 400 to optically detect a surface 402 of a workpiece 404, and includes a computer unit 428 with a computer program to detect dirt particles 426, 427 on the surface 402 of the workpiece 404 by evaluating a contrast of the workpiece surface 402. In some examples, the imaging system 400 comprises an endoscope probe 407 that can be positioned in workpiece bores, which includes a light source 408 to illuminate the wall 412 of the workpiece bore 406 and contains a wide angle lens 414 to optically image the wall 412 of the workpiece bore 406 on a light sensor 408. Some examples further include a positioning device 420 to move the endoscope probe 407 relative to a workpiece 404.

Some examples include a transporting device that is coupled to the assembly 130, 266 and which, as a function of the initial contamination S₁ detected for a workpiece 104, 204 by the computer 130, 270 and/or of the residual contamination S₂ detected for a workpiece 108, 208, either releases the workpiece 109, 209 to a system output after a cleaning process in the system 100, 200 or feeds the workpiece 108, 208 to a system input in order to repeat cleaning of the workpiece 108, 208 in the system. In some examples, the device 252 to continuously detect initial contamination S₁ of workpieces 204 provided to the at least one cleaning station 210, 212, 214 before cleaning, and/or the device 254 for continuously detecting residual contamination S₂ of workpieces 208 after cleaning in the at least one cleaning station 210, 212, 214, contains a system 300 to determine a dirt particle load in cleaning fluid that is used for the cleaning of a workpiece by rinsing. In some examples, the system 300 contains a light source 310 to generate light beams 314 that penetrate a test volume 312 containing cleaning fluid, and includes an optical sensor 315 to detect the intensity of the light beams 314 that penetrate the test volume 312. In some examples, the system 300 includes a device 302, 305 to remove air bubbles from cleaning fluid provided to the test volume 312. In some examples, the system contains an inductive measuring device to detect dirt particles in the cleaning fluid.

Another example method includes detecting initial contamination S₁ of workpieces 204 before cleaning, detecting residual contamination S₂ of workpieces 208 after cleaning, and determining a system operating state A, B, C from the detected initial contamination S₁ and the detected residual contamination S₂.

Another example method includes detecting initial contamination S₁ of workpieces 104 provided to the system before cleaning, detecting residual contamination S₂ of workpieces 108 after cleaning, and for the initial contamination S₁ detected for a workpiece 104, setting at least one process parameter P to clean the workpiece 104 the system 100 with a functional rule P=F_{S2}(S₁) that is dependent on the detected initial contamination S₁ and the detected residual contamination S₂.

This patent arises from a continuation-in-part of International Patent Application No. PCT/EP2012/068510, which was filed on Sep. 20, 2012, which claims priority to German Patent Application No. 10 2011 083 081, which was filed on Sep. 20, 2011, German Patent Application No. 10 2012 200 612, which was filed on Jan. 17, 2012, and German Patent Application 10 2012 200 614, which was filed on Jan. 17, 2012. The foregoing International Patent Application and German Patent Applications are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A system for cleaning workpieces, comprising:
at least one cleaning station having a cleaning device to apply a cleaning fluid to a workpiece;
a sensor to detect initial contamination of the workpieces provided to the at least one cleaning station before cleaning;
a sensor to detect residual contamination of the workpieces after cleaning in the at least one cleaning station; and
a computer coupled to the sensor to detect the initial contamination and to the sensor to detect the residual contamination, wherein
the computer determines a system malfunction from a comparison of the initial contamination with a first threshold value and from a comparison of the final contamination with a second threshold value, and wherein the system malfunction results from one or more of
the determined initial contamination undershoots the first threshold value and the determined final contamination exceeds the second threshold value,
the determined initial contamination exceeds the first threshold value and the determined final contamination exceeds the second threshold value, or
the determined final contamination remains substantially constant for successive workpieces and exceeds the second threshold value with an absolute value that remains substantially constant.

2. The system as defined in claim 1, wherein the computer is coupled to a warning signal generator to display a determined system malfunction.

3. The system as defined in claim 1, wherein the computer calculates and sets, based on the initial contamination detected for the workpieces and the detected residual contamination with a functional rule dependent on the continuously detected initial contamination and the detected residual contamination, a system process parameter in the form of one or more of a temperature of a cleaning fluid that is applied to the workpieces, a chemical composition of a cleaning fluid that is applied to the workpieces, a pressure of a cleaning fluid which is applied to the workpieces, a volume flow of cleaning fluid that is applied to the workpieces, a length of a time interval in which the workpieces are subjected to a cleaning process in a cleaning station, an intensity of an ultrasonic signal, input into the cleaning fluid for cleaning the workpieces or the number of the workpieces provided to the system per time unit.

4. The system as defined in claim 1, further comprising
a transporting device coupled to the computer and which, as a function of the initial contamination detected for a workpiece by the computer and/or of the residual contamination detected of a workpiece, either releases the workpiece to a system output after a cleaning process in the system or feeds it to a system input in order to repeat cleaning of the workpiece in the system.

5. The system as defined in claim 1, wherein the sensor to detect initial contamination of the workpieces provided to one or more of the at least one cleaning station before cleaning or the sensor to detect residual contamination of the workpieces after cleaning in the at least one cleaning station, comprises a system to determine a dirt particle load in cleaning fluid used to the clean a workpiece by rinsing.

6. The system as claimed in claim 5, wherein the system comprises one or more of a light source to generate light beams to penetrate a test volume containing cleaning fluid, an optical sensor to detect the intensity of the light beams, a device to remove air bubbles from cleaning fluid provided to the test volume, or an inductive measuring sensor to detect dirt particles in the cleaning fluid.

7. The system as defined in claim 1, wherein one or more of the sensor to detect initial contamination or the sensor to detect residual contamination determines a dirt particle load in a test volume of a measuring device of a cleaning fluid used to rinse a workpiece in a cleaning section.

8. The system as defined in claim 1, wherein the sensor to detect residual contamination and/or the sensor to detect initial contamination has an imaging system to optically detect a surface of a workpiece, and has a computer with a computer program to detect dirt particles on the surface of the workpiece by evaluating a contrast of the workpiece surface.

9. The system as defined in claim 8, wherein the imaging system comprises an endoscope probe to be positioned in workpiece bores, the endoscope probe comprises a light source to illuminate the wall of the workpiece bore and comprises a wide angle lens to optically image the wall of the workpiece bore by a light sensor.

10. The system as defined in claim 9, further comprising a positioning device to move the endoscope probe relative to a workpiece.

11. A system for cleaning workpieces, comprising:
at least one cleaning station having a cleaning device to apply cleaning fluid to a workpiece;
a sensor to detect initial contamination of the workpieces provided to the at least one cleaning station before cleaning;
a sensor to detect residual contamination of the workpieces after cleaning in the at least one cleaning station; and
a computer coupled to the sensor to detect initial contamination and to the sensor to detect residual contamination,
wherein the computer calculates and sets, on the basis of the initial contamination detected for the workpieces and the detected residual contamination with a functional rule based on the detected initial contamination and the detected residual contamination, a system process parameter in the form of one or more of a temperature of a cleaning fluid that is applied to the workpieces, a chemical composition of a cleaning fluid which is applied to the workpieces, a pressure of a cleaning fluid that is applied to the workpieces, a volume flow of cleaning fluid that is applied to the workpieces, a length of a time interval in which the workpieces are subjected to a cleaning process in a cleaning station, an intensity of an ultrasonic signal input into the cleaning fluid for cleaning a workpiece, or a number of the workpieces provided to the system per time unit.

12. The system as defined in claim 11, wherein the computer determines, based on a comparison of the initial contamination with a first threshold value and a comparison of the final contamination with a second threshold value, a system malfunction resulting from one or more of
the determined initial contamination undershoots the first threshold value and the determined final contamination exceeds the second threshold value,
the determined initial contamination exceeds the first threshold value and the determined final contamination exceeds the second threshold value, or
the determined final contamination remains substantially constant for successive workpieces and exceeds the second threshold value with an absolute value that remains substantially constant.

13. The system as defined in claim 11, wherein the computer is coupled to a warning signal generator to display a determined system malfunction.

14. The system as defined in claim 11, wherein the computer determines the functional rule dependent on the initial and residual contamination, with a closed-loop control circuit based on a deviation of the detected residual contamination from a residual contamination setpoint value, and the functional rule is stored as a characteristic curve diagram in data memory of the computer.

15. The system as defined in claim 11, wherein one or more of the sensor to detect initial contamination or the sensor to detect residual contamination determines a dirt particle load in a test volume of a measuring device of a cleaning fluid used to rinse a workpiece in a cleaning section.

16. The system as defined in claim 11, wherein the sensor to detect residual contamination and/or the sensor to detect initial contamination has an imaging system to optically detect a surface of a workpiece, and has a computer with a computer program to detect dirt particles on the surface of the workpiece by evaluating a contrast of the workpiece surface.

17. The system as defined in claim 16, wherein the imaging system comprises an endoscope probe to be positioned in workpiece bores, the endoscope probe comprises a light source to illuminate the wall of the workpiece bore and comprises a wide angle lens to optically image the wall of the workpiece bore by a light sensor.

18. The system as defined in claim 17, further comprising a positioning device to move the endoscope probe relative to a workpiece.

19. The system as defined in claim 11, further comprising a transporting device coupled to the computer and which, as a function of the initial contamination detected for a workpiece by the computer and/or of the residual contamination detected of a workpiece, either releases the workpiece to a system output after a cleaning process in the system or feeds it to a system input in order to repeat cleaning of the workpiece in the system.

20. The system as defined in claim 11, wherein the sensor to detect initial contamination of the workpieces provided to one or more of the at least one cleaning station before cleaning or the sensor to detect residual contamination of the workpieces after cleaning in the at least one cleaning station, comprises a system to determine a dirt particle load in cleaning fluid used to the clean a workpiece by rinsing.

21. The system as claimed in claim 20, wherein the system comprises one or more of a light source to generate light beams to penetrate a test volume containing cleaning fluid, an optical sensor to detect the intensity of the light beams, a device to remove air bubbles from cleaning fluid provided to the test volume, or an inductive measuring sensor to detect dirt particles in the cleaning fluid.

22. A method for monitoring a system for cleaning workpieces, in particular in a system, comprising:
detecting initial contamination of the workpieces before cleaning;
detecting residual contamination of the workpieces after cleaning; and
determining a system malfunction, via a processor, from a comparison of the initial contamination with a first threshold value and from a comparison of the final contamination with a second threshold value, the system malfunction determined from one or more of
the determined initial contamination undershoots the first threshold value and the determined final contamination exceeds the second threshold value,
the determined initial contamination exceeds the first threshold value and the determined final contamination exceeds the second threshold value, or
the determined final contamination remains substantially constant for successive workpieces and exceeds the second threshold value with an absolute value which remains substantially constant.

23. A method for performing open-loop and/or closed-loop control of at least one process parameter to clean workpieces, comprising:
detecting initial contamination of workpieces provided to the system before cleaning;
detecting residual contamination of the workpieces after cleaning; and
determining a system process parameter, via a processor, based on the initial contamination detected and the detected residual contamination with a functional rule dependent on the detected initial contamination and the detected residual contamination, the system process parameter determined based on one or more of a temperature of a cleaning fluid that is applied to workpieces, a chemical composition of a cleaning fluid that is applied to workpieces, a pressure of a cleaning fluid that is applied to the workpieces, a volume flow of cleaning fluid applied to the workpieces, a duration of a time interval in which the workpieces are subjected to a cleaning process in a cleaning station, an intensity of an ultrasonic signal input into the cleaning fluid to clean a workpiece, or a number of the workpieces provided to the system per time unit.
